(19) United States
(12) Patent Application Publication
(10) Pub. No.: US 2009/0265933 A1
(43) Pub. Date: Oct. 29, 2009

(54) Method for the manufacture of turbine or compressor rotors for gas-turbine engines

(76) Inventor: Karl Schreiber, Am Mellensee (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/385,918

(22) Filed: Apr. 23, 2009

(30) Foreign Application Priority Data
Apr. 24, 2008 (DE) 102008020624.5

(51) Int. Cl. B23P 15/04

(52) U.S. Cl. 29/889.21

(57) ABSTRACT

With the manufacture of turbine engine rotor drums, the opposite joining surfaces of rotor disks are brought into contact and at least one of the two rotor disks clamped into a fixture is set in a circular movement until the joining areas reach a pasty state due to the frictional heat. The circular movement of the rotor disks, in which the axis of the rotor disk moves along a circular path, is optically recorded and deviations due to imbalance are corrected by weight compensation at the fixture. Upon reaching the pasty material state the joining areas weld together, with the rotor disks being at rest and in axial alignment. Manufacture is cost-effective and guarantees precise axial alignment of the rotor disks and a long service life of the engine rotor drums.

This application claims priority to German Patent Application DE102008020624.5 filed Apr. 24, 2008, the entirety of which is incorporated by reference herein.

This invention relates to a method for the manufacture of two or multi-stage turbine or compressor rotors for gas-turbine engines, in which two or several rotor disks are welded to each other on laterally abutting joining surfaces.

Two-stage or multi-stage turbine or compressor rotors of gas-turbine engines usually include two or several pre-manufactured rotor disks provided with integral blading or separately attachable blading and made of high-temperature resistant materials, such as nickel, titanium or iron-base alloys. In accordance with the respective loading, rotor disks made of different alloys are also combined in one and the same rotor drum. As is generally known, the rotor disks are joined to each other by threaded connections. This method is however disadvantageous in that the use of fasteners entails increased weight and high effort for the production of the interference fits at the connection points as well as for the assembly of the rotor disks and, finally, the correction of imbalance.

Specification DE 10348424A1 describes the manufacture of engine rotor drums having several rotor disks welded to each other. The starting and end points of a weld produced by electron-beam welding are, however, weak points which reduce the life of the welded joint. Moreover, different materials and different expansion characteristics may lead to the formation of cracks during welding so that the required mechanical strength is not ensured. The quality of the welds between the individual rotor disks is, however, crucial for the mechanical properties of the entire engine drum.

It has also been proposed to join the rotor disks by rotary friction welding, but the successful application of this process is problematic in that the joined components are not adequately alignable due to uncontrollable imbalance. Moreover, the high forces involved with the large mass of the rotor disks require considerable equipment investment.

A broad aspect of the present invention is to provide a cost-effective method for the manufacture of engine rotor drums having rotor disks welded to each other, which ensures a high quality of the weld as well as exact and balanced alignment of the rotor disks welded together.

In other words, the basic idea of the present invention is that the joining surfaces of the rotor disks to be joined by welding perform a circular movement on each other and are thereby heated, with the two joining surfaces welding together upon reaching a pasty state and being again brought to standstill and into axial alignment relative to each other. The circular movement performed in the process is no self-rotation of the rotor disk(s), but the axis of the rotor disks(s) moves on a circular path. In the heating phase, the circular movement of the rotor disks is optically recorded to balance the fixture during the heating phase and obtain uniform and complete heating of both joining areas and precise axial alignment between the two rotor disks upon standstill of the two joining surfaces at the end of the heating phase. The method, while being cost-effectively performable with low apparatus investment, produces weld joints characterized by high quality and long service life. The balanced, circular movement provides for consistently formed weld joints, rotor disks precisely set in one axis and balanced engine rotor drums.

In development of the present invention, the circular movement can be performed either by only one rotor disk or by both rotor disks. In order to minimize driving forces and imbalance, the heavier component, i.e. the assembly of several welded rotor disks, is preferably at rest during the heating phase and only the lighter component, i.e. the rotor disk to be added to the welded assembly, performs the circular movement. The circular movement, if made by both rotor disks, is preferably co-directional and preferably offset by 180 degrees.

In a further development of the present invention, the rotary speeds and/or the radius of the circle of movement and/or the frictional forces acting upon the joining surfaces are variable, actually in dependence of the materials and the size and/or mass of the rotor disks to be joined. The movement parameters can vary between the rotor disks to be joined or between different types of rotor drums.

The method can be applied for the manufacture of engine rotor drums made of different materials, in particular nickel, titanium or iron-base alloys. In accordance with the thermal loading, rotor disks which are made of different materials can, however, also be welded together in one and the same engine rotor drum.

The invention is hereinafter explained in more detail by way of an example for the manufacture of a two-stage engine rotor drum for a high-pressure turbine having two rotor disks joined to each other by welding. The two rotor disks, in accordance with the different thermal loading in the respective turbine stage, are made of different titanium-base alloys, here Ti 6246 and Ti 6242, for example. However, other titanium, nickel or iron-base alloys can also be combined and welded to each other.

The two rotor disks are clamped into an oscillating fixture performing minute, circular movements and pressed onto each other at their joining surfaces. The rotary oscillatory movement here required for joining the two large-area and relatively heavy rotor disks—which is balanced by optical measuring methods using compensation weights—is co-directional, but offset by 180 degrees. Since the circular movement produces friction on a relatively large area of the two joining surfaces, the material of both rotor disks in the joining plane will, with only small pressure applied, heat up relatively rapidly and uniformly in all areas. Other relative movements between the joining surfaces can also be used. When the materials have reached a pasty state over a certain thickness from the joining plane, the circular oscillatory movement is stopped, upon which the two rotor disks are realigned in one axis relative to each other and join with each other in the plastic state of the material surfaces, essentially without bulging.

However, it is also possible that only one of the two rotor disks performs the circular movement—for example with increased rotary speed—while the other rotor disk is firmly clamped and immobilized. This variant is applied in particular if a single, light rotor disk is to be welded to a welded assembly of two or several rotor disks to minimize the effort for driving and balancing the machine.

What is claimed is:

1. A method for manufacturing a plurality of turbine/compressor rotors for gas-turbine engines, comprising:
welding at least two pre-fabricated rotor disks to each other on laterally abutting joining surfaces, the welding including:
bringing the joining surfaces of the rotor disks into areal contact with one another,
setting in movement at least one of the two rotor disks held in a driven fixture,
heating the joining surfaces by frictional contact movement until they reach a pasty state,
optically monitoring movement of the two rotor disk for axial alignment,
correcting any deviation from axial alignment by compensation at the fixture, and
immobilizing the two rotor discs while in axial alignment with one another until the pasty state solidifies sufficiently to maintain the axial alignment.

2. The method of claim 1, wherein both of the rotor disks are moved circularly and co-directionally, but offset to each other by a certain circular angle.

3. The method of claim 2, wherein, at least one of a rotary speed, a radius of circular movement and frictional forces acting upon the joining surfaces are variable in dependence of at least one of a size, mass, and material(s) of the rotor disks to be joined.

4. The method of claim 3, wherein one of the rotor disks with less mass is set in a circular movement and the rotor disk with more mass, including a rotor disc with at least one additional rotor disc already assembled thereto, is at rest.

5. The method of claim 4, wherein the joining surface performing a circular movement on the immobilized joining surface is moved at at least one of an increased rotary speed and an increased radius to enhance the relative movement between the two joining surfaces.

6. The method of claim 5, wherein the rotor disks are made of the same materials.

7. The method of claim 5, wherein the rotor disks are made of dissimilar materials.

8. The method of claim 6, wherein rotor disks made of at least one of nickel, titanium and iron-base alloys are welded together.

9. The method of claim 1, wherein one of the rotor disks with less mass is set in a circular movement and the rotor disk with more mass, including a rotor disc with at least one additional rotor disc already assembled thereto, is at rest.

10. The method of claim 9, wherein the joining surface performing a circular movement on the immobilized joining surface is moved at at least one of an increased rotary speed and an increased radius to enhance the relative movement between the two joining surfaces.

11. The method of claim 10, wherein the rotor disks are made of the same materials.

12. The method of claim 10, wherein the rotor disks are made of dissimilar materials.

13. The method of claim 12, wherein rotor disks made of at least one of nickel, titanium and iron-base alloys are welded together.

14. The method of claim 1, wherein the rotor disks are made of the same materials.

15. The method of claim 1, wherein the rotor disks are made of dissimilar materials.

16. The method of claim 1, wherein rotor disks made of at least one of nickel, titanium and iron-base alloys are welded together.
